(19) United States
(12) Patent Application Publication
(10) Pub. No.: US 2011/0169186 A1
(43) Pub. Date: Jul. 14, 2011

(54) Method for Producing Three Separate and Distinct Intake Manifolds from a Single Intake Manifold Casting For Three Different Multi-Cylinder Internal Combustion Engine Applications

(76) Inventors: Brenda Bruman, Shelby Twp, MI (US); Marcello Tedesco, Shelby Twp, MI (US)

(21) Appl. No.: 13/004,476

(22) Filed: Jan. 11, 2011

Related U.S. Application Data
(60) Provisional application No. 61/293,964, filed on Jan. 11, 2010.

(51) Int. Cl. B29C 37/00; B29C 39/02

(52) U.S. Cl. 264/138; 264/297.8

(57) ABSTRACT

A method for producing different distinct intake manifolds from a single intake manifold casting mold. It is the objective of the present invention to reduce costs and tooling for the manufacturing of different intake manifolds by using a single intake manifold casting mold. The intake manifolds created by the casting mold are then differentiated for a corresponding engine by means of modifications. The intake runners of the intake manifolds are machine cut to fit the corresponding cylinder heads of the combustion engine. The modifications to the intake modification ensure maximum air flow efficiency for greater engine performance.

The current application claims a priority to the U.S. Provisional Patent application Ser. No. 61/293,964 filed on Jan. 11, 2010.

### FIELD OF THE INVENTION

The present invention relates generally to a method of manufacturing a plurality of distinct intake manifolds from a single intake manifold casting for different multi-cylinder internal combustions engines. More specifically, the present invention allows users to make use of a single manifold casting to create different modified intake manifolds for different engines.

### BACKGROUND OF THE INVENTION

Traditionally, to manufacture an intake manifold, a mold casting is used to create the shapes and features of the intake manifold. However, to create different intake manifolds with different features, manufacturers are required to make use of a completely different and separate cast mold. The necessity of a separate intake manifold casting requires more time and resources to create. The curves and shapes for an intake manifold are extremely important to the air flow efficiency. The air flow efficiency in turn strongly influences the performance of an engine. Each curve and bend of an intake manifold can affect the efficiency of the air flow. For this reason, the precision of the manufacturing of the intake manifolds are extremely important. To ensure that the precision of manufacture is kept for each intake manifold, the separate and different mold castings are used to create the intake manifolds. To manufacture the different intake manifolds separately requires time and additional resources. The present invention is a method of manufacturing different intake manifolds using a single mold casting. The present invention aims to overcome the use of separate manifold mold castings to cut down on inefficient manufacturing practices. The present invention allows manufacturers to produce intake manifolds that are applicable to a number of different engines with different shaped and sized cylinder heads.

### BRIEF DESCRIPTION OF THE DRAWINGS

FIG. 1 is a perspective view of the resulting intake casting formed by the present invention.

FIG. 2 is a bottom plan view of the resulting intake casting formed by the present invention.

FIG. 3 is a perspective view of the different casting cores of the intake mold used to produce a distinct intake manifold from the present invention.

FIG. 4 is a perspective view of the different casting cores of the intake mold used to produce another distinct intake manifold from the present invention.

FIG. 5 is a bottom plan view of the different casting cores of the intake mold used to produce an intake manifold from the present invention.

FIG. 6 is a front elevational view of the different casting cores of the intake mold used to produce an intake manifold from the present invention.

### DETAIL DESCRIPTIONS OF THE INVENTION

All illustrations of the drawings are for the purpose of describing selected versions of the present invention and are not intended to limit the scope of the present invention.

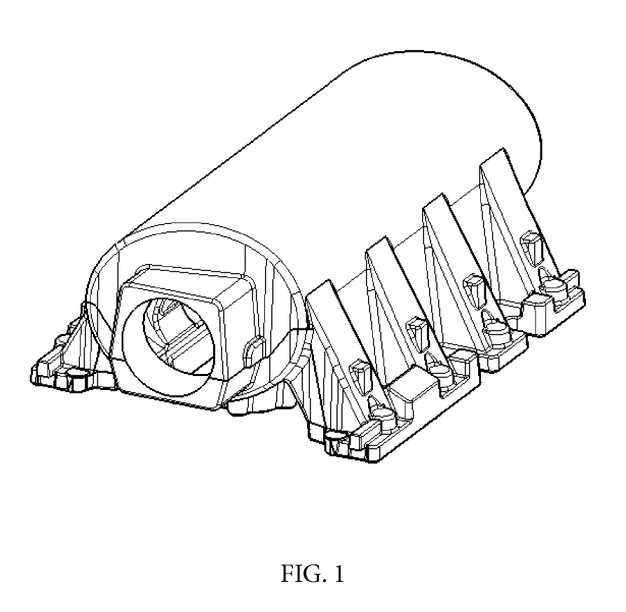

In reference to FIG. 1, the present invention relates to an improvement in the method for producing different and distinct intake manifolds from a single intake manifold casting for different multi-cylinder combustion engine applications. The present invention makes use of an intake mold 1 that is shaped to create an intake manifold. It is the objective of the present invention to reduce the costs for tooling and manufacturing the different types of intake manifolds. It is also the objective of the present invention to manufacture the different intake manifolds to specific geometric configurations to best fit different engine cylinder head inlet ports. It is furthermore the objective of the present invention to create intake manifolds that are able to optimize the performance of its corresponding engines.

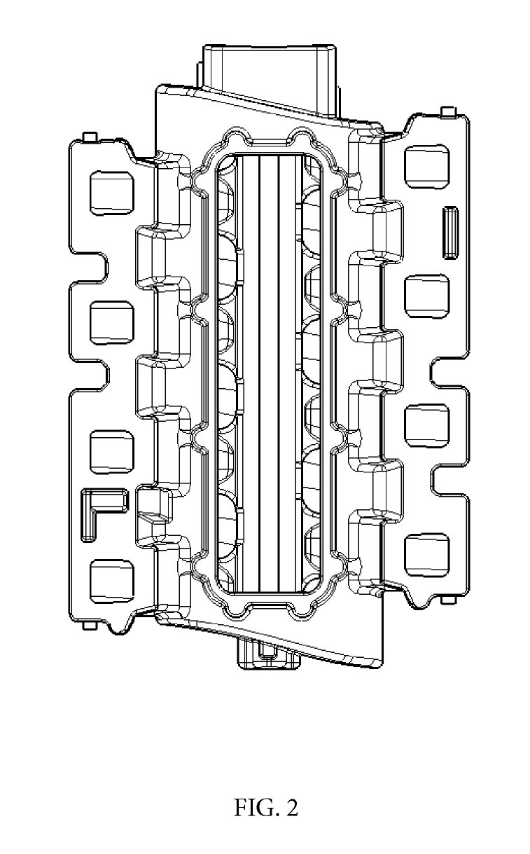

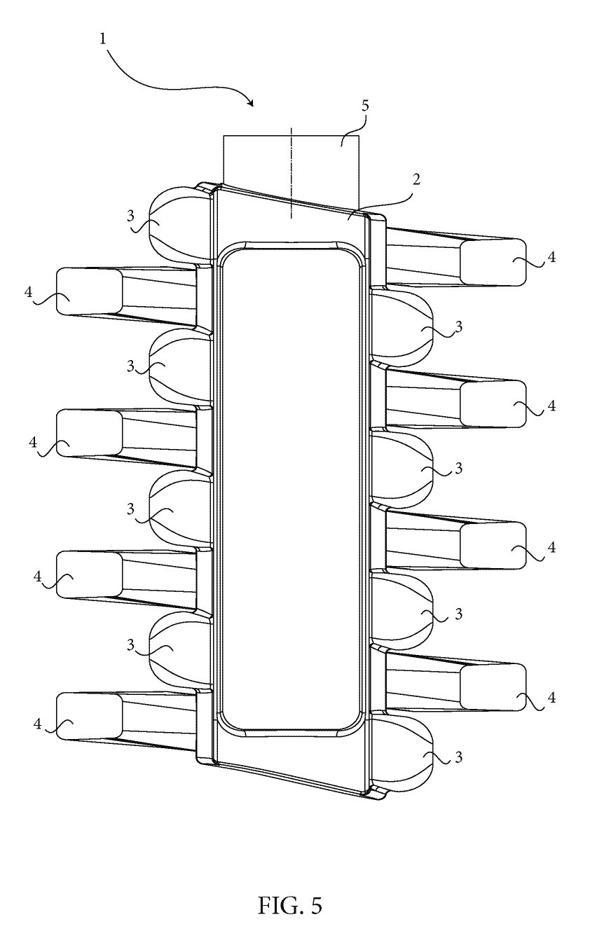

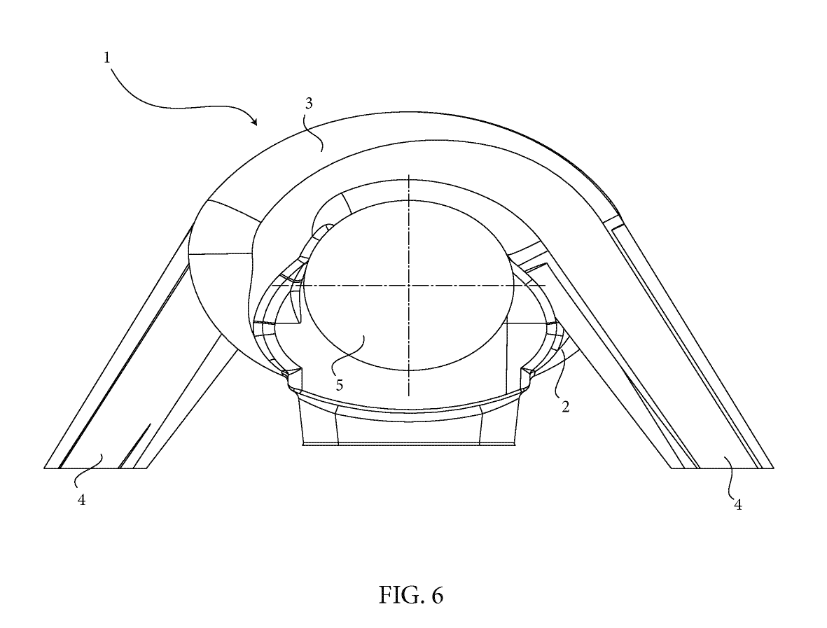

In reference to FIG. 1-6, to manufacture the different distinct intake manifolds, the method of the present invention first makes use of an intake mold 1 that is used for casting an intake manifold. The intake manifold will be manufactured with a plurality of intake runners that directs air flow from a plenum chamber to the cylinder heads. To additionally form and detail the plurality of intake runners, the present invention also provides a plurality of core cavities 2 for receiving a plurality of casting cores 3 to further form the plurality of intake runners. Although, the intake mold 1 is able to form the shape of the plurality of intake runners, the present invention comprises a plurality of solid casting cores 4 to shape the internal passageways for the plurality of intake runners. The internal passageways provide the plurality of intake runners a hollow channel on the intake manifold leading into the plenum chamber. The plurality of solid casting cores 4 provide the plurality of intake runners with a smooth bend and curve that leads into the plenum chamber. The intake mold 1 additionally comprises a chamber solid casting core 5 for the forming of the internal plenum chamber of the intake manifold. The intake mold 1 is able to form an intake manifold material into the appropriate intake manifold. However, before the intake manifold material is poured into the intake mold 1, the plurality of core cavities 2, the plurality of solid casting cores 4, and the chamber casting core is secured in place with the intake mold 1 to ensure integrity of the end product. Once secured, the intake manifold material is poured into the intake mold 1 around the plurality of core cavities 2, the plurality of solid casting cores 4, and the chamber casting core to form the intake manifold. The intake manifold material is a sturdy heat resistant material selected from the group consisting of liquid nylon, polymers, and metal. The use of nylon or polymers is advantageous in its light weight. With lighter weight, the overall burden of the vehicle using the intake manifold is lessened. As a result the overall performance of the vehicle is increased. However, the nylons and other types of polymers have a lesser resistance to heat and can still deform when exposed to excessive heat. In the preferred embodiment of the present invention, the intake manifold material is preferred to be metal. The metal can be melted into molten metal and poured into the intake mold 1 to create a metal intake manifold. Once the intake manifold has cooled and solidified, the intake mold 1 can be removed from the intake manifold. The plurality of core cavities 2, the plurality of solid casting cores 4, and the chamber casting core can also be removed from the intake manifold.

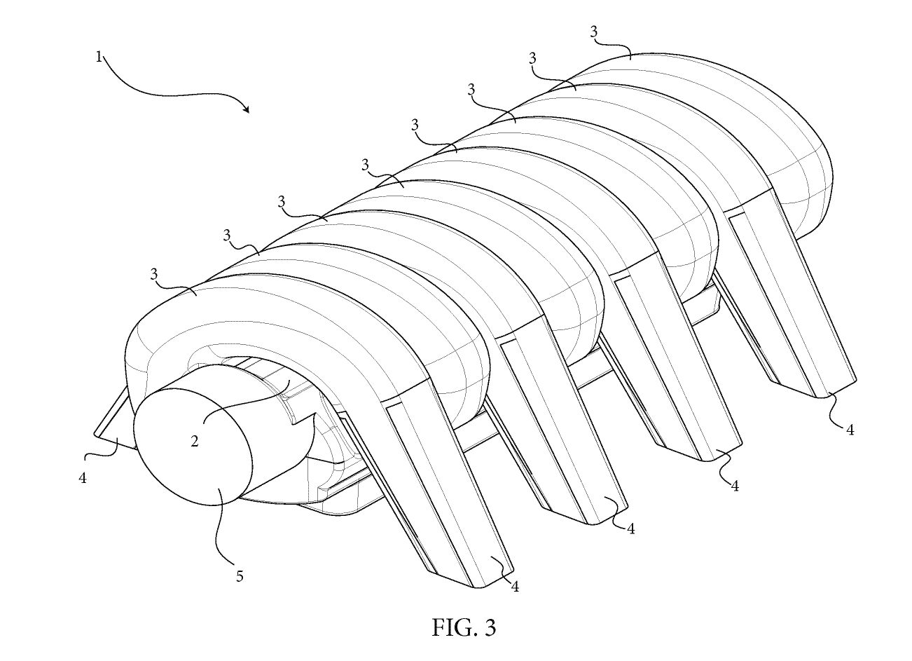

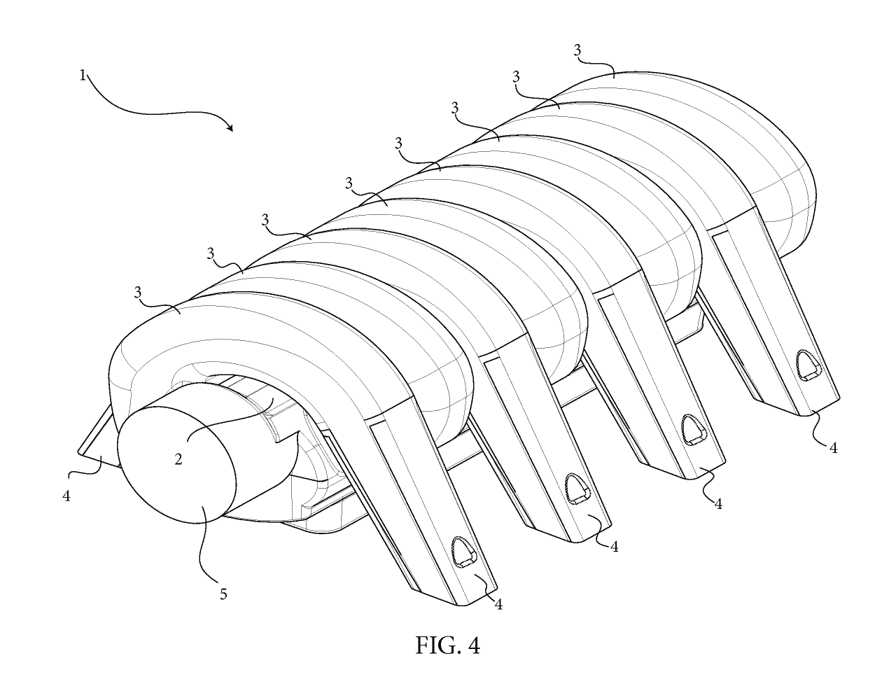

The placement of the plurality of solid casting cores 4 affects the compatibility of the resulting intake manifold with the cylinder heads of an engine. The plurality of solid casting cores 4 are alternatively inserted in a parallel manner, as shown in FIG. 3-4. Each of the solid casting cores are arranged in parallel fashion. However, they are arranged in a crisscross fashion to accommodate the design of the design of the cylinder heads to the corresponding combustion engines. The plurality of solid casting cores 4 provides the intake manifolds with the plurality of intake runners for corresponding communication to individual ports of the corresponding engine cylinder heads with the internal plenum chamber. The plurality of solid casting cores 4 and the plurality of casting cores 3 together are shaped in a partial logarithmic spiral shape to provide the plurality of intake runners of the intake manifold a channel leading from the engine cylinder heads to the internal plenum chamber. The plurality of solid casting cores 4 is positioned about the chamber solid casting core 5 to circumscribe and define the intake plenum chamber of the intake manifold.

To further customize the intake manifolds into the different types of combustion engines, the internal passageways of the plurality of intake runners are further modified. The modification of the plurality of intake runners further separates the types of intake manifolds created by the method of the present invention. The plurality of intake runners has runner openings leading into the internal passageways. The internal passageways have an inner side and an outer side. The inner side is the side of the internal passageways that is closer to the internal plenum chamber. The outer side is the side of the internal passage ways that is further away from the internal plenum chamber. The intake manifolds are then differentiated by means of the different machine cuts made to the runner openings of the intake runners to precisely match the shapes and configurations of inlet ports of each specific engine cylinder heads. Additionally, to further provide a smooth transition of the internal channels of the internal passage way to the engine cylinder heads of the combustion engines, the inner side or the outer side of the internal passageways can be partially cut to optimize air flow, air velocity, and pressure distribution. The smooth transition is able to optimize the air flow efficiency of between the intake manifold and the engine. Resultantly, the performance of the engine using the intake manifold created by the present invention is increased. By allowing partial machine cuts on the inner side or the outer side, the manufactures are able to create three distinct intake manifolds. In reference to FIG. 4, one possible intake manifold can have only the inner side partially cut for smooth air flow transition. Another possible intake manifold can have only the outer side partially cut for smooth air flow transition. The last possible intake manifold involves the partial machine cutting of both the inner side and the outer side for smooth air flow transition. These partial machine cutting ensure there are not sudden changes in cross sectional area between the connection of the plurality of intake runners and the cylinder heads of the combustion engine. It is most efficient for the change in cross sectional area of the channels of the plurality of intake runner to gradual taper towards the cylinder heads. With sudden changes in the cross sectional area of the channels, the air flow efficiency is interrupted by rigid corners.

Although the invention has been explained in relation to its preferred embodiment, it is to be understood that many other possible modifications and variations can be made without departing from the spirit and scope of the invention as hereinafter claimed.

What is claimed is:

1. A method for producing three distinct intake manifolds from a single intake manifold casting for three different multi-cylinder internal combustion engine applications comprises,
providing an intake mold being shaped for casting an intake manifold;
providing by the intake mold a plurality of intake runners for the intake manifold;
providing by the intake mold a plurality of core cavities for receiving a plurality of casting cores to form the plurality of intake runners;
providing by the intake mold a plurality of solid casting cores to shape internal passageways for the plurality of intake runners;
providing by the intake mold a chamber solid casting core to shape an internal plenum chamber for the intake manifold;
securing the plurality of core cavities, the plurality of solid casting cores, and the chamber casting core in place with the intake mold to ensure integrity;
pouring an intake manifold material into the intake mold around the plurality of core cavities, the plurality of solid casting cores, and the chamber casting core to form the intake manifold;
removing of intake mold; and
removing of the plurality of core cavities, the plurality of solid casting cores, and the chamber casting core from the intake manifold.

2. The method for producing three distinct intake manifolds from a single intake manifold casting for three different multi-cylinder internal combustion engine applications as claimed in claim 1 comprises,
the intake manifold material being a sturdy heat resistant material being selected from the group consisting of liquid nylon, polymers, and metal.

3. The method for producing three distinct intake manifolds from a single intake manifold casting for three different multi-cylinder internal combustion engine applications as claimed in claim 1 comprises,
the plurality of solid casting cores being alternatively inserted in a parallel manner to one another; and
the plurality of solid casting cores providing the intake manifold with the plurality of intake runners for corresponding communication to individual ports of corresponding engine cylinder heads with the internal plenum chamber.

4. The method for producing three distinct intake manifolds from a single intake manifold casting for three different multi-cylinder internal combustion engine applications as claimed in claim 3 comprises,
the plurality of solid casting cores and the plurality of casting cores being shaped in a logarithmic spiral shape to provide the plurality of intake runners of the intake manifold a channel leading from the engine cylinder heads to the internal plenum chamber; and
the plurality of solid casting cores being arranged in an alternating manner to correspond to the positioning of the engine cylinder heads.

5. The method for producing three distinct intake manifolds from a single intake manifold casting for three different multi-cylinder internal combustion engine applications as claimed in claim 4 comprises,
the plurality of solid casting cores being positioned about and leading to the chamber solid casting core to circumscribe the plenum chamber of the intake manifold.

6. The method for producing three distinct intake manifolds from a single intake manifold casting for three different multi-cylinder internal combustion engine applications as claimed in claim 1 comprises,
the plurality of intake runners having runner openings leading into the internal passageways;
machine cutting the runner openings of the intake runners to precisely match shapes and configurations of inlet ports of each specific engine cylinder head;
machine cutting partially of the internal passageways to optimize air flow, air velocity and pressure distribution at the runner openings of the intake manifold;
the plurality of solid casting cores being shaped to create the different distinct intake manifolds; and
the internal passageways having an inner side and an outer side.

7. The method for producing three distinct intake manifolds from a single intake manifold casting for three different multi-cylinder internal combustion engine applications as claimed in claim 6 comprises,
wherein the partial machining cutting of the internal passageways cuts the inner side to provide a smooth transition from the internal passageways to the engine cylinder heads.

8. The method for producing three distinct intake manifolds from a single intake manifold casting for three different multi-cylinder internal combustion engine applications as claimed in claim 6 comprises,
wherein the partial machining cutting of the internal passageways cuts the outer side to provide a smooth transition from the internal passageways to the engine cylinder heads.

9. A method for producing three distinct intake manifolds from a single intake manifold casting for three different multi-cylinder internal combustion engine applications comprises,
providing an intake mold being shaped for casting an intake manifold;
providing by the intake mold a plurality of intake runners for the intake manifold;
providing by the intake mold a plurality of core cavities for receiving a plurality of casting cores to form the plurality of intake runners;
providing by the intake mold a plurality of solid casting cores to shape internal passageways for the plurality of intake runners;
providing by the intake mold a chamber solid casting core to shape an internal plenum chamber for the intake manifold;
securing the plurality of core cavities, the plurality of solid casting cores, and the chamber casting core in place with the intake mold to ensure integrity;
pouring an intake manifold material into the intake mold around the plurality of core cavities, the plurality of solid casting cores, and the chamber casting core to form the intake manifold;
removing of intake mold;
removing of the plurality of core cavities, the plurality of solid casting cores, and the chamber casting core from the intake manifold;
the plurality of intake runners having runner openings leading into the internal passageways;
machine cutting the runner openings of the intake runners to precisely match shapes and configurations of inlet ports of each specific engine cylinder head;
machine cutting partially of the internal passageways to optimize air flow, air velocity and pressure distribution at the runner openings of the intake manifold;
the plurality of solid casting cores being shaped to create the different distinct intake manifolds; and
the internal passageways having an inner side and an outer side.

10. The method for producing three distinct intake manifolds from a single intake manifold casting for three different multi-cylinder internal combustion engine applications as claimed in claim 9 comprises,
the intake manifold material being a sturdy heat resistant material being selected from the group consisting of liquid nylon, polymers, and metal.

11. The method for producing three distinct intake manifolds from a single intake manifold casting for three different multi-cylinder internal combustion engine applications as claimed in claim 9 comprises,
the plurality of solid casting cores being alternatively inserted in a parallel manner to one another; and
the plurality of solid casting cores providing the intake manifold with the plurality of intake runners for corresponding communication to individual ports of corresponding engine cylinder heads with the internal plenum chamber.

12. The method for producing three distinct intake manifolds from a single intake manifold casting for three different multi-cylinder internal combustion engine applications as claimed in claim 11 comprises,
the plurality of solid casting cores and the plurality of casting cores being shaped in a logarithmic spiral shape to provide the plurality of intake runners of the intake manifold a channel leading from the engine cylinder heads to the internal plenum chamber; and
the plurality of solid casting cores being arranged in an alternating manner to correspond to the positioning of the engine cylinder heads.

13. The method for producing three distinct intake manifolds from a single intake manifold casting for three different multi-cylinder internal combustion engine applications as claimed in claim 12 comprises,
the plurality of solid casting cores being positioned about and leading to the chamber solid casting core to circumscribe the plenum chamber of the intake manifold.

14. The method for producing three distinct intake manifolds from a single intake manifold casting for three different multi-cylinder internal combustion engine applications as claimed in claim 9 comprises,
wherein the partial machining cutting of the internal passageways cuts the inner side to provide a smooth transition from the internal passageways to the engine cylinder heads.

15. The method for producing three distinct intake manifolds from a single intake manifold casting for three different multi-cylinder internal combustion engine applications as claimed in claim 9 comprises,
wherein the partial machining cutting of the internal passageways cuts the outer side to provide a smooth transition from the internal passageways to the engine cylinder heads.

16. A method for producing three distinct intake manifolds from a single intake manifold casting for three different multi-cylinder internal combustion engine applications comprises,
providing an intake mold being shaped for casting an intake manifold;
providing by the intake mold a plurality of intake runners for the intake manifold;
providing by the intake mold a plurality of core cavities for receiving a plurality of casting cores to form the plurality of intake runners;
providing by the intake mold a plurality of solid casting cores to shape internal passageways for the plurality of intake runners;
providing by the intake mold a chamber solid casting core to shape an internal plenum chamber for the intake manifold;
securing the plurality of core cavities, the plurality of solid casting cores, and the chamber casting core in place with the intake mold to ensure integrity;
pouring an intake manifold material into the intake mold around the plurality of core cavities, the plurality of solid casting cores, and the chamber casting core to form the intake manifold;
removing of intake mold;
removing of the plurality of core cavities, the plurality of solid casting cores, and the chamber casting core from the intake manifold;
the plurality of intake runners having runner openings leading into the internal passageways;
machine cutting the runner openings of the intake runners to precisely match shapes and configurations of inlet ports of each specific engine cylinder head;
machine cutting partially of the internal passageways to optimize air flow, air velocity and pressure distribution at the runner openings of the intake manifold;
the plurality of solid casting cores being shaped to create the different distinct intake manifolds;
the internal passageways having an inner side and an outer side;
the plurality of solid casting cores being alternatively inserted in a parallel manner to one another;
the plurality of solid casting cores providing the intake manifold with the plurality of intake runners for corresponding communication to individual ports of corresponding engine cylinder heads with the internal plenum chamber;
the plurality of solid casting cores and the plurality of casting cores being shaped in a logarithmic spiral shape to provide the plurality of intake runners of the intake manifold a channel leading from the engine cylinder heads to the internal plenum chamber; and
the plurality of solid casting cores being arranged in an alternating manner to correspond to the positioning of the engine cylinder heads.

17. The method for producing three distinct intake manifolds from a single intake manifold casting for three different multi-cylinder internal combustion engine applications as claimed in claim 16 comprises,
the intake manifold material being a sturdy heat resistant material being selected from the group consisting of liquid nylon, polymers, and metal.

18. The method for producing three distinct intake manifolds from a single intake manifold casting for three different multi-cylinder internal combustion engine applications as claimed in claim 16 comprises,
the plurality of solid casting cores being positioned about and leading to the chamber solid casting core to circumscribe the plenum chamber of the intake manifold.

19. The method for producing three distinct intake manifolds from a single intake manifold casting for three different multi-cylinder internal combustion engine applications as claimed in claim 16 comprises,
wherein the partial machining cutting of the internal passageways cuts the inner side to provide a smooth transition from the internal passageways to the engine cylinder heads.

20. The method for producing three distinct intake manifolds from a single intake manifold casting for three different multi-cylinder internal combustion engine applications as claimed in claim 16 comprises,
wherein the partial machining cutting of the internal passageways cuts the outer side to provide a smooth transition from the internal passageways to the engine cylinder heads.
